(19) United States
(12) Patent Application Publication
(10) Pub. No.: US 2008/0100058 A1
(43) Pub. Date: May 1, 2008

(54) MECHANICAL JOINT OF A HEAT EXCHANGER PIPE

(76) Inventors: Thomas Klotten, Koln (DE); Zdenek Fidler, Koprivnice (CZ); Stephan Koster, Langerwehe (DE); Pavel Bartos, Novy Jicin (CZ)

Correspondence Address: FRASER CLEMENS MARTIN & MILLER LLC, 28366 KENSINGTON LANE, PERRYSBURG, OH, 43551, US

(21) Appl. No.: 11/927,804

(22) Filed: Oct. 30, 2007

(30) Foreign Application Priority Data
Oct. 30, 2006 (DE) 102006051687.7

(51) Int. Cl. F16L 53/00; B23P 19/04; F28D 15/00; F16L 47/14

(52) U.S. Cl. 285/41; 165/104.19; 285/45; 29/700

(57) ABSTRACT

A mechanical joint for an accumulator-internal heat exchanger (AccuIHE) module is provided. The mechanical joint includes a heat exchanger pipe and a cover plate having an internal connecting area. The internal connecting area is adapted to receive the heat exchanger pipe. The cover plate further has an external connecting area in fluid communication with the internal connecting area, the external connecting area adapted to receive a high-pressure coolant line. The mechanical joint also has a housing adapted to receive the cover plate and the heat exchanger pipe, and a sealing element. The sealing element is disposed between the heat exchanger pipe and the internal connecting area of the cover plate. The sealing element facilitates a substantially fluid tight seal therebetween. An AccuIHE module having the mechanical joint and a method for forming the mechanical joint are also provided.

### CROSS-REFERENCE TO RELATED APPLICATIONS

This application claims the benefit of German Patent Application No. 102006051687.7 MECHANICAL JOINT OF A HEAT EXCHANGER PIPE filed on Oct. 30, 2006, hereby incorporated herein by reference in its entirety.

### FIELD OF THE INVENTION

The invention relates to a mechanical joint between a heat exchanger pipe and a cover plate of a modular unit (AccuIHE) comprised of an internal heat exchanger with accumulator.

### BACKGROUND OF THE INVENTION

The combined accumulator with internal heat integrates the functionalities of the two individual components into a single component. The integrated component is preferably used in mobile R744 refrigerating plants, in particular in coolant circulation systems for automotive air conditioning. In comparison to the individual components, the integrated, and hence compact, “AccuIHE” component is better tailored to the limited space available in the engine compartment, and also is cost effective relative to the overall system of the mobile refrigerating plant.

In a refrigerating machine or heat pump, the accumulator is downstream from the evaporator, and its job is to collect varying coolant fill quantities arising from different operating conditions, and to maintain a coolant reserve to counter the losses incurred through leaking in the maintenance interval.

The function of the internal heat exchanger is to transfer energy from the warm high-pressure side to the cold low-pressure side (suction side) for purposes of system internal supercooling, which in turn is heated or superheated as a result.

The combination of accumulator and internal heat exchanger can be realized by a coaxial design involving two concentrically arranged containers. The internal container acts as the accumulator. The annular gap between the internal and external container incorporates the internal heat exchanger. The latter most often consists of a heat exchanger pipe rolled into coiled tubing and arranged coaxially in the gap between the internal and external container. This coiled tubing can be comprised of plain-ended pipes, ribbed pipes or bundled pipes.

DE 31 19 440 A1 describes a system heat exchanger for refrigerating plants that exhibits an internal container arranged inside an external container, wherein a serpentine pipe for the coolant streaming from the capacitor to the evaporator is arranged in the space between the two containers. The outlet line of the evaporator here empties into this space, which is connected by an overflow opening with the internal container, from which aspiration to the compressor takes place.

DE 102 61 886 A1 describes a heat exchanger with two walls of varying circumference, in which the wall with the smaller circumference is located inside the larger circumference of the other wall. A cover is secured to an upper section of the first wall and upper section of the second wall, while a floor is attached to the two lower sections of the two walls. Situated between the two walls is a spiral pipeline, which at least in part does not contact either the first or second wall.

As a consequence, the internal heat exchanger and accumulator in an AccuIHE are usually accommodated in a cylindrical housing, which leads to the outside via terminal connections on the faces. These terminal connections require that the internal pipe ends preferably be linked from inside with the housing covers. The previous solutions derived from documents relating to prior art are characterized in that the cylindrical ends of the coiled tubing are routed through the external housing and sealed to the outside via welding, soldering or by means of threaded joints. A second threaded joint always further joins the components to the same pipe ends passed through and out of the AccuIHE. The disadvantage to such a solution lies in the fact that the connection points that project far from the component are very sensitive to damage.

Another disadvantage lies in the fact that the pipes are joined when passed through the cover or container floor via welding and soldering, a process that is complicated, expensive and not very safe. For example, the introduction of heat while joining materials can negatively affect the mechanical properties of the materials. In turn, this makes it necessary to use a higher wall thickness or higher-quality materials during mechanical layout, which are most often also more expensive to process. In addition, a cost-effective type of construction cannot be realized by joining materials from outside.

On the one hand, joining materials from the inside is associated with the same disadvantages as those mentioned above for joining materials from outside. On the other hand, when joining the lower connection, the coiled tubing must be pulled out of the housing by a specific length L. There is a danger that the coiled tubing might be destroyed in the process.

In compression joints, conventional cold forming involves holding the plain-ended pipe over a straight length and then exerting a force to form it in an axial direction. The disadvantage here is that the space required for both holding lengths L reduces the number of coil tubing turns, and hence the heat transfer surface between the accumulator and internal heat exchanger or thermal output given components of the same size. The height of the usable internal heat exchanger hence decreases by the two holding lengths L. This means that there is often not enough room available for joining via cold forming. In addition, the coiled tubing must be pulled out of the housing by holding length L when joining the second connection. As already mentioned, there is a danger of the coiled tubing being destroyed in the process.

Screwed joints are precluded given more than two terminal connections.

The object of the invention is to realize a safe and cost-effective mechanical joint between an internal heat exchanger (IHE) and a component cover and component container.

Accordingly, it would be desirable to produce a mechanical joint for use in joining a heat exchanger pipe with a cover plate of a modular unit comprised of an internal heat exchanger with an accumulator. Desirably, the mechanical joint between an internal heat exchanger (IHE) and a component cover and component container is safe and cost-effective.

### SUMMARY OF THE INVENTION

Consonant with the present invention, a safe and cost-effective mechanical joint between an internal heat exchanger pipe (IHE) and a cover plate of a component comprised of an internal heat exchanger with accumulator, is surprisingly discovered.

The underlying concept of the invention involves joining the pipe ends of the high-pressure passage of the internal heat exchanger with the cover plates or container floor from the inside. This means that the connection point of the internal heat exchanger to the component cover is shifted inside the component. In this case, the invention provides for two types of sealing planes.

A first, external sealing plane ensures that the component is sealed to the outside environment, and is preferably realized using joining techniques permitted for automotive applications.

The internal joints between the heat transfer pipe and component cover represent the second type, and are decoupled from the first, external sealing plane according to the invention. The job of the second, internal sealing plane is to prevent coolant from internally escaping the interior space of the heat exchanger exposed to a high pressure and flowing into the external space of the heat exchanger exposed to a low pressure. The invention makes use of the fact that the requirements placed on the tightness of internal joints are not as stringent in comparison to those for tightness relative to the system environment. A joint arranged inside the component or component cover must hence only be relatively tight, because a slight internal leak can be tolerated, as opposed to a loss of coolant to the outside. This eliminates the need for tightly joining materials, e.g., through welding or soldering, relative to the joint between the component and heat transfer pipe, thereby producing cost benefits.

The internal heat exchanger and accumulator together form a modular unit (AccuIHE). The combined component (AccuIHE) is encompassed by a housing with an upper and lower cover plate. The housing incorporates an accumulator, which collects the liquid coolant under a low pressure. The heat exchanger pipe for the coolant a high pressure is coiled in the gap, with a gap width s between the accumulator and housing. According to the invention, the ends of the heat exchanger pipe exhibit connecting areas for mechanically joining the heat exchanger pipe with the cover plate from inside. The cover plates exhibit the female contour that matches that of the connecting area of the heat exchanger pipe inside the cover plate passages at the high-pressure inlet and high-pressure outlet of the internal heat exchanger.

In a particularly favorable embodiment, the connecting areas of the heat exchanger pipe are provided with an external thread for joining to the cover plates from inside. To this end, the cover plate passage of the cover plates incorporate a respectively matching internal thread, so that the heat exchanger pipe can be screwed into the cover plates.

The upper cover plate advantageously incorporates the low-pressure inlet and high-pressure outlet of coolant circulating system. The lower cover plate then correspondingly accommodates the low-pressure outlet and high-pressure inlet of the coolant circulating system. After the heat exchanger pipe has been screwed into the respective cover plate, the heat exchanger pipe is preferably cold formed, during which the screwed threads provide support in an axial direction.

The mechanical joint is sealed in one advantageous embodiment by molding a sealing contour before the thread. In a further advantageous embodiment of the invention, the seal is realized by forming a sealing contour before the thread and compressing the thread. In addition, the heat exchanger pipe can be molded after the thread. In another embodiment, the seal can also be realized without forming a sealing contour solely by compressing the thread.

As an alternative, sealing elements that provide a radial seal can be used in place of cold forming. In a further embodiment of the invention, the mechanical joint is realized between an internal heat exchanger (IHE) and component cover by means of a thread and seal. In this case, the connecting area of the coiled heat exchanger pipe is provided with an external thread. However, an especially advantageous variant of a radial seal without thread is also possible. Omitting the thread greatly simplifies the joining of the component. When using such a sealing element without thread, the heat exchanger pipe can be mechanically joined with both the component cover and the component container.

In this case, a seal is advantageously secured to the pipe end of the heat exchanger pipe. On the one hand, this seal can be a cylindrical seal made out of an elastic or plastic material, e.g., in the form of a Teflon conical nipple. On the other hand, an O-ring seal can also be used as the seal, wherein one or more O-rings are possible.

The cover plates each exhibit an internal thread that matches the external thread. The connecting area of the heat exchanger pipe is screwed into the cover plate. The seal is then advantageously achieved by radially compressing the sealing element. Axial sealing is here not advantageous, since this makes it impossible to achieve the correct position of the cover plate relative to the spiral of the heat exchanger pipe.

In an alternative approach to achieving the object of the invention, the pipe end of the coiled heat exchanger pipe can be left smooth. The corresponding female contour is then imparted to the covers. In this solution, the spiral coil is inserted into the cover and welded into the cover with a friction welding mandrel passed through the terminal connection.

In one embodiment, a mechanical joint for an accumulator-internal heat exchanger (AccuIHE) module includes a heat exchanger pipe and a cover plate having an internal connecting area formed therein. The internal connecting area is adapted to receive the heat exchanger pipe. The cover plate further has an external connecting area in fluid communication with the internal connecting area. The external connecting area is adapted to receive a high-pressure coolant line therein and facilitate a coolant flow through the heat exchanger pipe. The mechanical joint also has a housing adapted to receive the cover plate and the heat exchanger pipe, and a sealing element. The sealing element is disposed between the heat exchanger pipe and the internal connecting area of the cover plate. The sealing element facilitates a substantially fluid tight seal therebetween.

In another embodiment, an accumulator-internal heat exchanger (AccuIHE) module for use in a vehicle cooling system includes a modular unit. The modular unit includes an internal heat exchanger and an accumulator. The AccuIHE module further has a housing with a first end and a second end. The modular unit is disposed in the housing. A first heat exchanger pipe is also included in the AccuIHE module. A first cover plate is disposed on the first end of the housing and has a first internal connecting area formed therein. The first internal connecting area is adapted to receive the first heat exchanger pipe. The first internal connecting area is also in fluid communication with a first external connecting area adapted to receive a high-pressure coolant line and facilitate a coolant flow to the first heat exchanger pipe. The AccuIHE module further includes a first sealing element disposed between the first heat exchanger pipe and the first internal connecting area of the first cover plate. The first sealing element forms a substantially fluid tight seal between the first heat exchanger pipe and the first internal connecting area.

In a further embodiment, a method for of forming a mechanical joint for an accumulator-internal heat exchanger (AccuIHE) module includes steps of: providing a heat exchanger pipe; providing a cover plate having an internal connecting area formed therein adapted to receive the heat exchanger pipe, the cover plate further having an external connecting area in fluid communication with the internal connecting area, the external connecting area adapted to receive a high-pressure coolant line and facilitate a coolant flow therethrough; and providing a sealing element on at least one of the heat exchanger pipe and the internal connecting area to facilitate forming a substantially fluid tight seal therebetween. The heat exchanger pipe is disposed in the internal connecting area of the cover plate, thereby forming the mechanical joint.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1a is a combined component AccuIHE having an internal heat exchanger and accumulator of the prior art;

FIG. 1b is a combined component AccuIHE having an internal heat exchanger and accumulator of the prior art, in which the coiled tubing is pulled out for internal welding to the cover;

FIG. 2 is a combined component having an internal heat exchanger and accumulator after joining via cold forming of the prior art;

FIG. 3a is a mechanical joint between the heat exchanger pipe and the upper or lower cover plate established with a screw coupling and molding process, showing the heat exchanger pipe and a cover plate prior to screw coupling;

FIG. 3b is a mechanical joint between the heat exchanger pipe and the upper or lower cover plate established with a screw coupling and molding process, showing the heat exchanger pipe and a cover plate after screw coupling, prior to expansion of the thread by means of a mandrel;

FIG. 3c is a mechanical joint between the heat exchanger pipe and the upper or lower cover plate established with a screw coupling and molding process, showing the realized mechanical joint;

FIG. 4a is a mechanical joint between the heat exchanger pipe and the upper or lower cover plate established with a thread and seal, the seal being an O-ring seal;

FIG. 4b is a mechanical joint between the heat exchanger pipe and the upper or lower cover plate established with a thread and seal, the seal being a cylindrical seal;

FIG. 5a is a mechanical joint between the heat exchanger pipe and the upper or lower cover plate without a thread, and with an O-ring seal; and

FIG. 5a is a mechanical joint between the heat exchanger pipe and the upper or lower cover plate without a thread, and with two O-ring seals.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

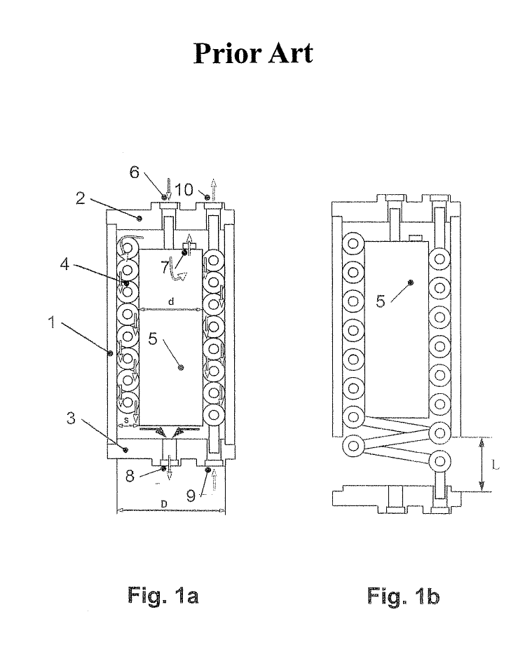

FIG. 1a depicts a combined component (AccuIHE) consisting of an internal heat exchanger and accumulator according to prior art. This component is comprised of an internal heat exchanger with a coiled heat exchanger pipe, which together with an accumulator forms a modular unit. The internal heat exchanger consists of a housing 1, which is designed as a circular cylinder with an interior diameter D. The housing 1 is bordered by an upper cover plate 2 and lower cover plate 3. The upper cover plate 2 integrates the low-pressure inlet 6 and high-pressure outlet 10. The lower cover plate 3 integrates the low-pressure outlet 8 and the high-pressure inlet. The accumulator 5 is placed inside in the form of a concentrically arranged cylinder sealed from below with diameter d. The upper covering surface of the accumulator cylinder has the opening for the low-pressure inlet 6 next to an opening designed as the overflow 7. The coolant under a high pressure flows through the coiled heat exchanger pipe 4 that extends from the lower cover plate 3, is arranged in the gap with the gap width s between the accumulator 5 and housing 1, and spirals upwardly from below, coaxially along the exterior wall of the accumulator 5 to exit the internal heat exchanger via the high-pressure outlet 10 through the upper cover plate 2.

As depicted on FIG. 1b, joining the lower terminal connection requires that the coiled heat exchanger pipe 4 with length L be pulled out of the housing 1, giving rise to the danger that the latter might be destroyed in the process (prior art).

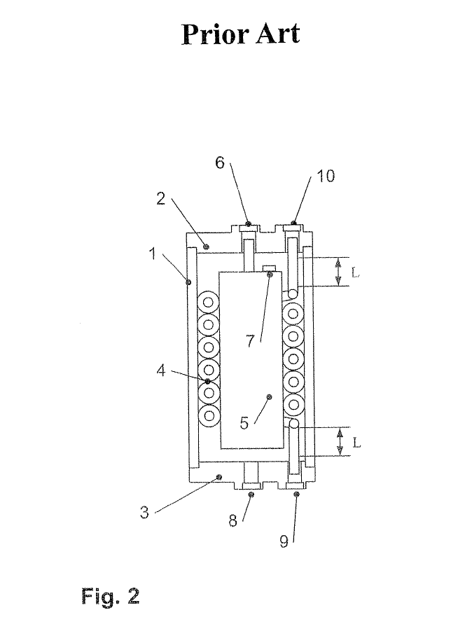

FIG. 2 illustrates the disadvantage to the conventional cold forming of plain-ended pipes according to prior art. In this case, the coiled heat exchanger pipe 4 is held over a straight length, and then formed in an axial direction through the exertion of force. The disadvantage here is that the space required for both holding lengths L reduces the number of coiled heat exchanger pipe 4 turns, and hence the exchanger surface, or thermal output given components of the same size. The height of the usable internal heat exchanger decreases by 2×L, as depicted on FIG. 2. In addition, coiled heat exchanger pipe 4 must be pulled out of the housing 1 by holding length L when establishing the lower connection. The danger is here that the heat exchanger pipe 4 might be destroyed.

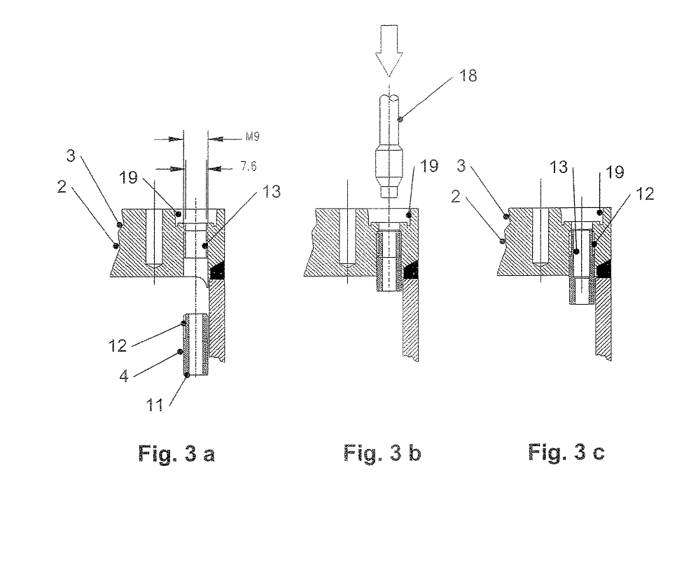

FIGS. 3a to 3c illustrate the joint between the coiled heat exchanger pipe 4 and the upper cover plate 2 or lower cover plate 3. The mechanical joint can be obtained by way of a molding process. According to FIG. 3a, the internal connecting area 11 of the coiled heat exchanger pipe 4 is provided with an external thread 12. The cover plates 2, 3 a matching internal thread 13. Prior to the molding process, the internal connecting area 11 of the coiled heat exchanger pipe 4 is first screwed into the cover 2, 3. Once the threads 12, 13 according to FIG. 3b have been screwed together, cold forming takes place. Axial support is here realized by the screwed threads 12, 13.

The internal connecting area 11 can be sealed from the coiled heat exchanger pipe 4 to the cover plates 2, 3 as follows: 1) Forming a sealing contour before threads 12, 13; 2) Forming a sealing contour before threads 12, 13 and compressing the threads 12, 13, wherein the heat exchanger pipe 4 with the external thread 12 is expanded by a mandrel 18, and pressed or compressed into the borehole with the internal thread 13, eliminating the play and freedom of movement of the threads 12, 13 in favor of tightness; 3) Forming a sealing contour before threads 12, 13 and compressing threads 12, 13 with a mandrel 18 for expanding and additionally molding the heat exchanger pipe 4 after thread 12; and 4) Only compressing threads 12, 13 with a mandrel 18 for expansion purposes.

The external connecting area 19 to the cover plates 2, 3 exhibits terminals for the high-pressure coolant lines.

FIG. 3c shows the realized mechanical joint between the internal heat exchanger (IHE) and the upper or lower cover plate 2, 3.

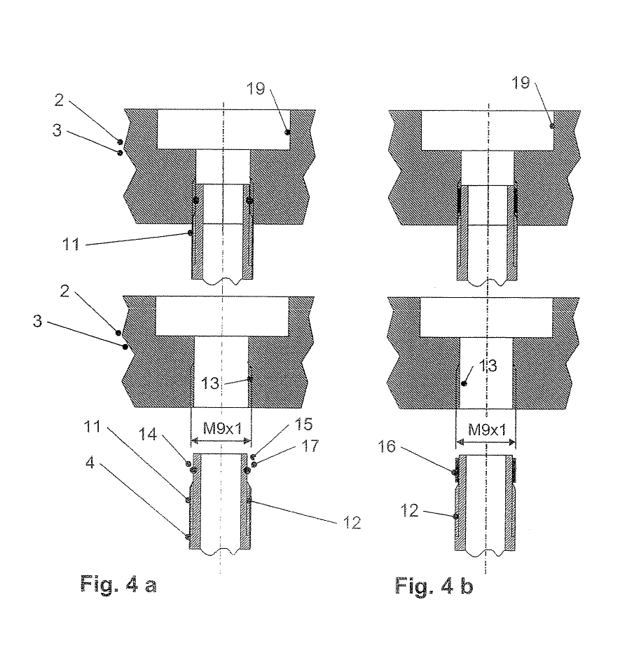

FIGS. 4a and 4b show the mechanical joint with thread and seal. The internal connecting area 11 of the coiled heat exchanger pipe 4 is here provided with an external thread 12. In addition, a seal 14 is placed on the pipe end 15 of the coiled heat exchanger pipe 14. This type of embodiment per FIGS. 4a and 4b is advantageous for reasons relating to assembly. As an alternative, however, the seal can also be placed in a groove in the respective covers 2, 3 instead of on the heat exchanger pipe 4. On the one hand, the seal 14 can be a cylindrical seal 16 comprised of elastic or plastic material as depicted on FIG. 4b, e.g., in the form of a Teflon conical nipple. On the other hand, an O-ring seal 17 according to FIG. 4a can be used as the seal 14, wherein one or more O-rings are possible. The cover plates 2, 3 exhibit an internal thread 13. The internal connecting area 11 of the coiled heat exchanger pipe 4 is screwed into the respective cover plate 2, 3. The seal 14 is achieved by radially compressing the respectively used sealing element 16, 17. Axial sealing is not advantageous, since this makes it impossible to achieve the correct position for the respective cover plate 2, 3 for the spiral of the coiled heat exchanger pipe 4.

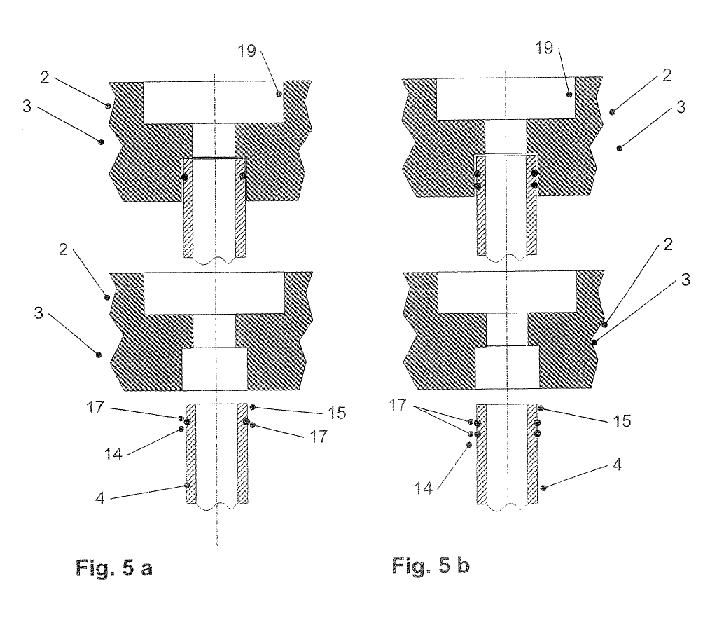

FIGS. 5a and 5b show an especially preferred embodiment of the mechanical joint, which exhibits at least one O-ring seal 17, wherein no thread is provided, as opposed to the other embodiments. According to FIG. 5a, a seal 14 is here secured to the pipe end 15 of the coiled heat exchanger pipe 4 as the sealing element in the form of an O-ring seal 17. By contrast, FIG. 5b depicts an embodiment with two O-ring seals 17 positioned one atop the other. The seal 14 is achieved by radially compressing the at least one O-ring seal 17.

While certain representative embodiments and details have been shown for purposes of illustrating the invention, it will be apparent to those skilled in the art that various changes may be made without departing from the scope of the disclosure, which is further described in the following appended claims.

What is claimed is:

1. A mechanical joint for an accumulator-internal heat exchanger (AccuIHE) module, the mechanical joint comprising:
a heat exchanger pipe;
a cover plate having an internal connecting area formed therein adapted to receive the heat exchanger pipe, the cover plate further having an external connecting area in fluid communication with the internal connecting area, the external connecting area adapted to receive a high-pressure coolant line therein and facilitate a coolant flow through the heat exchanger pipe;
a housing adapted to receive the cover plate and the heat exchanger pipe; and
a sealing element disposed between the heat exchanger pipe and the internal connecting area of the cover plate to facilitate a substantially fluid tight seal therebetween.

2. The mechanical joint according to claim 1, further comprising a first sealing contour formed on the heat exchanger pipe and a second sealing contour formed in the internal connecting area of the cover plate.

3. The mechanical joint according to claim 2, wherein the sealing element is disposed between the first contour and the second contour to form the substantially fluid tight seal.

4. The mechanical joint according to claim 1, wherein the heat exchanger pipe includes an external thread formed thereon.

5. The mechanical joint according to claim 4, wherein the internal connecting area includes an internal thread formed thereon adapted to receive the external thread formed on the heat exchanger.

6. The mechanical joint according to claim 5, wherein the internal thread and the external thread cooperate to provide an axial support to a first end of the heat exchanger pipe.

7. The mechanical joint according to claim 1, wherein the sealing element is a cylindrical seal disposed on an outer surface of the heat exchanger pipe.

8. The mechanical joint according to claim 1, wherein the sealing element is an O-ring disposed on an outer surface of the heat exchanger pipe.

9. The mechanical joint according to claim 1, wherein the sealing element is a friction weld.

10. The mechanical joint according to claim 1, wherein the sealing element is formed from a polymeric material.

11. The mechanical joint according to claim 10, wherein the polymeric material is one of a plastic material and an elastomeric material.

12. An accumulator-internal heat exchanger (AccuIHE) module for use in a vehicle cooling system, the AccuIHE module comprising:
a modular unit including an internal heat exchanger and an accumulator;
a housing with a first end and a second end, the modular unit disposed in the housing;
a first heat exchanger pipe;
a first cover plate disposed on the first end of the housing, the first cover plate having a first internal connecting area formed therein adapted to receive the first heat exchanger pipe, the first internal connecting area in fluid communication with a first external connecting area adapted to receive a high-pressure coolant line and facilitate a coolant flow to the first heat exchanger pipe; and
a first sealing element disposed between the first heat exchanger pipe and the first internal connecting area of the first cover plate, the first sealing element forming a substantially fluid tight seal between the first heat exchanger pipe and the first internal connecting area.

13. The AccuIHE module according to claim 12, further comprising:
a second heat exchanger pipe; and
a second cover plate disposed on the second end of the housing, the second cover plate having a second internal connecting area formed therein, wherein the second internal connecting area is in fluid communication with a second external connecting area formed in the second cover plate, the second external connecting area adapted to receive a high-pressure coolant line and facilitate a coolant flow to the second heat exchanger pipe.

14. The AccuIHE module according to claim 13, further comprising:
a second sealing element disposed between the second heat exchanger pipe and the second internal connecting area, the second sealing element forming a substantially fluid tight seal between the second heat exchanger pipe and the second internal connecting area.

15. The AccuIHE module according to claim 12, wherein the first heat exchanger pipe is one of a plurality of heat exchanger pipes.

16. A method of forming a mechanical joint for an accumulator-internal heat exchanger (AccuIHE) module, the method comprising the steps of:
providing a heat exchanger pipe;
providing a cover plate having an internal connecting area formed therein adapted to receive the heat exchanger pipe, the cover plate further having an external connecting area in fluid communication with the internal connecting area, the external connecting area adapted to receive a high-pressure coolant line and facilitate a coolant flow therethrough;
providing a sealing element on at least one of the heat exchanger pipe and the internal connecting area to facilitate forming a substantially fluid tight seal therebetween; and
disposing the heat exchanger pipe in the internal connecting area of the cover plate.

17. The method according to claim 16, further comprising the step of:
applying an outward radial force to the heat exchanger pipe to facilitate an expansion of the heat exchanger pipe against the internal connecting area.

18. The method according to claim 16, wherein the heat exchanger pipe includes an external thread formed thereon and the internal connecting area includes an internal thread formed thereon, the internal thread adapted to receive the external thread.

19. The method according to claim 18, further comprising the steps of:
forming a sealing contour on at least one of the heat exchanger pipe and the internal connecting area, the sealing contour formed on a portion of the at least one of the heat exchanger pipe and the internal connecting area adjacent the external threads and the internal threads; and
compressing the external threads and the internal threads by application of an outward radial force to the heat exchanger pipe to militate against a relative movement between the heat exchanger pipe and the internal connecting area.

20. The method according to claim 17, wherein the radial force is applied with a mandrel inserted into the external connecting area to expand the heat exchanger pipe.
